(19) United States
(12) Patent Application Publication
(10) Pub. No.: US 2026/0162512 A1
(43) Pub. Date: Jun. 11, 2026

(54) INTERNET OF THINGS ALERT DEVICES WITH DYNAMIC DETECTION OVERLAYS

(71) Applicant: INTERNATIONAL BUSINESS MACHINES CORPORATION, ARMONK, NY (US)

(72) Inventors: Charbak Chatterjee, Kolkata (IN); Chinmohan Biswas, Kolkata (IN); Debajyoti Mukherjee, Kolkata (IN)

(21) Appl. No.: 18/969,348

(22) Filed: Dec. 5, 2024

(51) Int. Cl. G08B 21/18; G06V 40/20; G08B 17/10; H04W 4/38

(52) U.S. Cl. CPC G08B 21/182; G06V 40/20; G08B 17/10; H04W 4/38

(57) ABSTRACT

According to one embodiment, a method, computer system, and computer program product for operating alert generating devices to issue an alarm is provided. The present invention may include capturing, by a plurality of internet of things (IoT) sensors, sensor data in real time within an IoT environment; extracting contextual data from the sensor data, wherein the extracting further comprises identifying, by a material model, a material and a flammability associated with the material comprising an object within the IoT environment; calculating a hazard risk based on the contextual data; responsive to the hazard risk exceeding a threshold amount, selecting one or more alarm generator devices based on the contextual data and the hazard risk; and executing an alert action on the one or more selected alarm generator devices.

### BACKGROUND

The present invention relates, generally, to the field of computing, and more particularly to Internet of Things.

The Internet of Things (IoT) is a collection of devices such as vehicles, home appliances, computers, mobile devices, sensors, and any real-world object embedded with networking technology which are capable of connecting, interacting, and exchanging data with each other over a network. IoT technology allows multiple devices to work together and accomplish tasks or provide information far beyond the capabilities of each individual device. As IoT technologies have evolved, they have revolutionized such fields as home automation, manufacturing, agriculture, transportation, medicine, healthcare, energy management and more. Wherever there are two or more connected devices, IoT technology may be harnessed to solve problems.

### SUMMARY

According to one embodiment, a method, computer system, and computer program product for operating alert generating devices to issue an alarm is provided. The present invention may include capturing, by a plurality of internet of things (IoT) sensors, sensor data in real time within an IoT environment; extracting contextual data from the sensor data, wherein the extracting further comprises identifying, by a material model, a material and a flammability associated with the material comprising an object within the IoT environment; calculating a hazard risk based on the contextual data; responsive to the hazard risk exceeding a threshold amount, selecting one or more alarm generator devices based on the contextual data and the hazard risk; and executing an alert action on the one or more selected alarm generator devices.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an alert analyzer process according to at least one embodiment; and

FIG. 3 illustrates an exemplary alert analyzer system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to the Internet of Things. The following described exemplary embodiments provide a system, method, and program product to, among other things, operate alert devices to perform alert actions based on analyzing the movement and behaviors of humans and/or objects in an environment.

As previously described, the Internet of Things (IoT) is a collection of devices such as vehicles, home appliances, computers, mobile devices, sensors, and any real-world object embedded with networking technology which are capable of connecting, interacting, and exchanging data with each other over a network. IoT systems lend themselves naturally to the purpose of hazard detection and emergency alert; interconnected IoT devices including sensors and alert devices may be strategically placed throughout an IoT environment such as a building, venue, campus, et cetera, where the IoT devices may assess and detect potential risks and hazards within the IoT environment such as smoke, fires, flooding, earthquakes, et cetera, and may activate alarms to alert occupants to the hazard and initiate emergency response procedures when a potential hazard is detected.

However, increasing complexity of buildings, density of occupation, and user expectations are heightening the need for accuracy and reliability in the methods and systems relied upon to keep users safe, and in turn increasing the urgency of introducing governance to ensure that life safety equipment fulfils its purpose of preventing emergencies and saving lives. Practical attempts to implement life safety systems often encounter significant challenges, namely with respect to accuracy and reliability; life safety systems frequently fail to accurately assess the risk of a hazard, resulting in false identification of a hazard and the resulting execution of a false alarm. As an example, fire alarms caused by faulty or poorly tuned equipment account for a significant percentage of false alarms, incurring considerable costs. False alarms may reduce user confidence in the life safety system, resulting in slower response times which may endanger users during a true emergency. Furthermore, false alarms require evacuation of occupied buildings, which may result in injuries due to crowding and/or panic, as well as operational disruptions which may lead to lost productivity, delays, and financial loss. As such, improving the reliability and accuracy of life safety systems is of considerable importance in protecting users and preventing loss from the adverse effects of false alarms.

However, even where existing solutions in the art utilize various learning capabilities such as AI models to improve hazard detection and reduce false alarms, such systems still fail to consider important contextual information such as human action through conversations and gestures or the positioning and movement of non-living objects within the IoT environment. As such, it may be advantageous to, among other things, implement a system that considers user position, behaviors, and movement, as well as the position, count, and correlation strength of objects over time in assessing the risk of a hazard occurring within the IoT environment.

Therefore, the present embodiment has the capacity to improve the technical field of Internet of Things by utilizing additional context to inform the issuance of alerts, thereby improving the accuracy and reliability of the alerts, and reducing the number of false alarms issued by the system. Fewer false alarms in turn results in improved user confidence in the system, fewer injuries, fewer operational disruptions, less wear on the system from false activations, et cetera.

According to at least one embodiment, the invention is a method of capturing real-time sensor data, extracting contextual data including human contextual data and object contextual data from the sensor data, calculating a hazard risk based on the contextual data, assessing the presence of a hazard based on the hazard risk, and executing an alert on or more alarm generator devices responsive to determining that a hazard is present.

According to at least one embodiment, the invention is a system comprising a computer hosting an alert analyzer program, as well as a plurality of interconnected Internet of Things IoT devices placed throughout an IoT environment, where the IoT devices include audio sensors, video sensors, and alarm generator devices.

In an exemplary embodiment, a number of human occupants may gather in a meeting room that is part of the IoT environment to celebrate the success of a project. The team is celebrating the event by lighting candles on a cake, and taking every precaution. The alert analyzer program 108 may monitor the meeting room and determine that there are no combustible objects, and that the human occupants are not in combustible attire. Therefore, the alert analyzer program 108 may identify that the risk of fire is minimal, and may not set off the fire alarm even where the smoke detector in the room is detecting smoke from the candle. However, if additional participants joined the celebration, entering the meeting room with another cake with additional lighted candles, bringing the total number of participants in the room to close to the room's occupancy, the alert analyzer program 108 may identify a real risk of fire based on the crowding and the increased number of lit candles, and may trigger a fire alarm in the meeting room. Alternatively, if the number of participants were to remain low, but some of the participants were to be wearing large, flammable novelty hats, the alert analyzer program 108 may identify a high risk of fire based on the presence of flammable objects, and may trigger an alarm.

In another exemplary embodiment, a number of human occupants gather in a meeting room that is part of the IoT environment to celebrate the success of a project. One individual suggests that the group light sparklers as part of the celebrations, and several other members of the group express their support for the idea either verbally or through gestures. The alert analyzer program 108 may identify the group's intention to light the sparklers based on processing the audible conversation and by interpreting gestures, and may pre-emptively trigger alerts.

In embodiments, an alert analyzer system may be integrated into an industrial setting, where the alert analyzer program 108 may monitor machinery sounds for signs of wear and tear based on, for example, computer vision, signs of overheating, contextual objects, human presence, et cetera, and triggering immediate alerts to avoid accidents where the hazard risk exceeds a threshold.

In embodiments, an alert analyzer system may be integrated into various vehicle systems to continuously monitor critical parameters such as engine sound, occupancy, and driver gestures within the vehicle, and to raise an alarm if a hazard is detected based on such parameters.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to operate alert devices to perform alert actions based on analyzing the movement and behaviors of humans and/or objects in an environment.

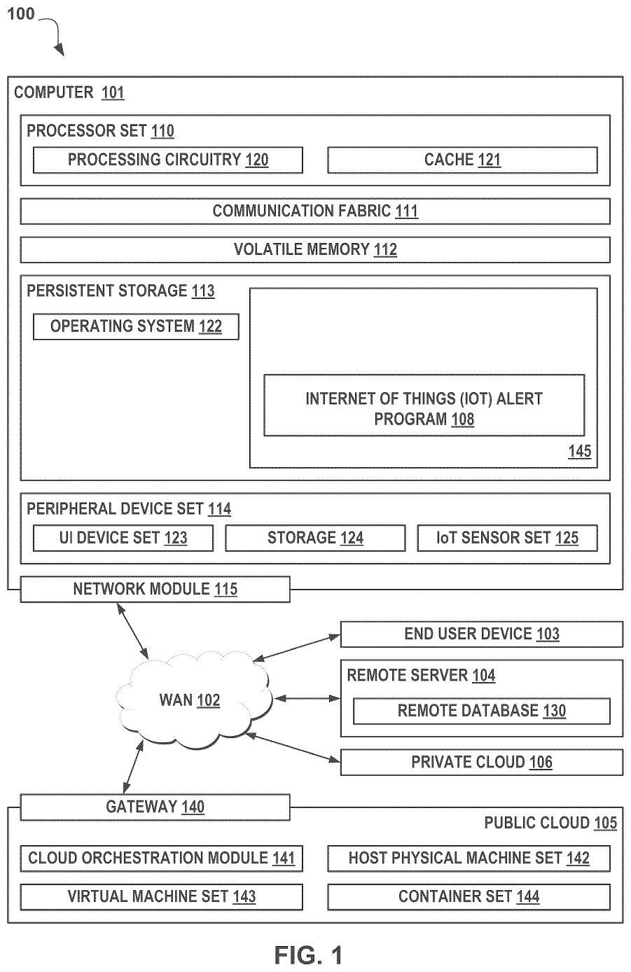

Referring now to FIG. 1, computing environment 100 contains an example of an environment for the execution of at least some of the computer code involved in performing the inventive methods, such as code block 145, which may comprise alert analyzer program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of IoT sensors that can be used in Internet of Things applications. The IoT sensors comprising IoT sensor set 125 may be devices that collect data about specific environmental or physical parameters in real time. The IoT sensors may be equipped with wireless communication technologies, such as Wi-Fi, Bluetooth, Zigbee, LTE, et cetera, by which the IoT sensors transmit collected data over WAN 102 to the alert analyzer program 108. The IoT sensors may include video sensors, audio sensors, air quality sensors, thermometers, hydrometers, et cetera.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

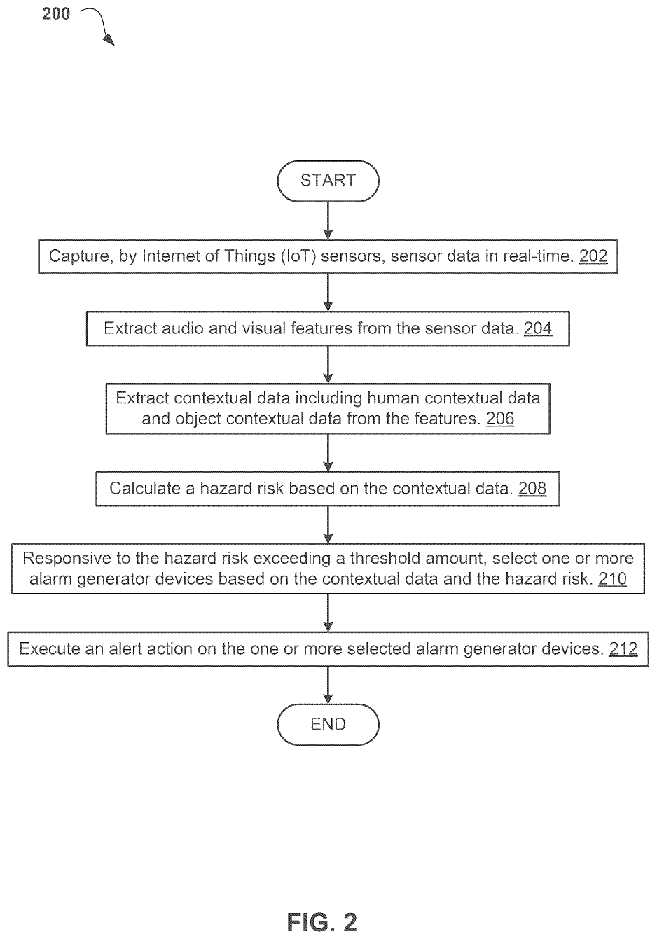

According to the present embodiment, the alert analyzer program 108 may be a program enabled to operate alert devices to perform alert actions based on analyzing the movement and behaviors of humans and/or objects in an environment. The alert analyzer program 108 may, when executed, cause the computing environment 100 to carry out an alert analyzer process 200. The alert analyzer process 200 may be explained in further detail below with respect to FIG. 2. In embodiments of the invention, the alert analyzer program 108 may be stored and/or run within or by any number or combination of devices including computer 101, end user device 103, remote server 104, private cloud 106, and/or public cloud 105, peripheral device set 114, and/or on any other device connected to WAN 102. Furthermore, alert analyzer program 108 may be distributed in its operation over any number or combination of the aforementioned devices.

Referring now to FIG. 2, an operational flowchart illustrating an alert analyzer process 200 is depicted according to at least one embodiment. At 202, the alert analyzer program 108 may capture, by IoT sensors, sensor data in real-time. The IoT sensors may comprise IoT sensor set 125, and may include video sensors and audio sensors. IoT audio and/or video sensors may be disposed within, and ingest inputs from, an IoT environment comprising a room, a suite, a building, et cetera; the sensors may record human speech, conversations & gestures. The IoT sensors may be grouped by location; for example, all IoT sensors in a particular room may be in a single group, such that all sensor data from the sensors in that group corresponds to environmental or physical parameters associated with that room. In embodiments, the IoT sensors may include one or more hazard sensors, which may be sensors that record information specifically associated with a particular hazard, such as seismographs, smoke detectors, carbon monoxide detectors, glass break sensors, et cetera.

In embodiments, the alert analyzer program 108 may retrieve event data for the IoT environment or locations within the IoT environment, such as scheduled or predicted meetings, conferences, seminars, et cetera, as well as historical data with respect to user activity within the IoT environment, such as historical trends and patterns regarding occupancy and movement within the IoT environment.

At 204, the alert analyzer program 108 may extract audio and visual features within from the sensor data. The features may be pieces of information about the content of the sensor data from an IoT environment that may be used to infer contextual data about the IoT environment, which in turn may be used to calculate a risk of a hazard occurring within the IoT environment. The features may include information such as instances of humans and objects appearing within the visual sensor data, instances of human speech or paralinguistic sounds occurring within the audio data, et cetera.

The alert analyzer program 108 may utilize natural language processing techniques and voice to text transformation, in combination with audio capture libraries, to detect human speech and human paralinguistic sounds within audio sensor data, and transcribe the detected speech and/or paralinguistic sounds into a text format.

The alert analyzer program 108 may utilize image processing techniques in conjunction with video capture libraries to identify human occupants and objects within the visual sensor data. The alert analyzer program 108 may label identified features within the sensor data. For example, in visual sensor data recorded during a business meeting, a frame of the video may contain five human employees who are attending the meeting, as well as a table, ten chairs, a projector, and a screen. The alert analyzer program 108 may identify the human occupants and the objects, place bounding boxes over each to indicate the region of the video frame where that human or object is located in the image, and label the region with the name of the human or object identified within. In embodiments, the alert analyzer program 108 may convert visual sensor data to natural language text, by generating a natural language description of a given image or video based on the visual features identified within the image or video.

The alert analyzer program 108 may further label each human or individual object with a unique identifier; when identifying new visual features, the alert analyzer program 108 may compare any newly detected human or object against previously detected humans or objects within the visual sensor data to determine whether the newly detected visual feature is an object or human that has been previously identified; if the visual feature has been previously identified, the alert analyzer program 108 may label the newly detected visual feature with the same unique identifier as the previously identified visual feature, so as to enable alert analyzer program 108 to identify the visual feature in successive video frames, and thereby track the motion of the human or object within the IoT environment.

In embodiments, the alert analyzer program 108 may analyze successive images comprising a video of individual human occupants and/or objects to extract the movements of individual humans and/or objects within the IoT environment. The alert analyzer program 108 may utilize computer vision techniques and/or, in embodiments, a dedicated controller for motion detection to detect the movements, and may output movement data associated with each human occupant and/or object.

The alert analyzer program 108 may utilize image processing techniques and video-to-text transformation to detect written speech within visual sensor data, and may transcribe the written speech into a text format.

At 206, the alert analyzer program 108 may extract contextual data including human contextual data and object contextual data from the features. Contextual data may be information that further describes an object, human occupant, or the IoT environment, describes a semantic relationship between two or more objects, human occupants, and/or the IoT environment, defines an intent of a human occupant as expressed through gesture, behavior, or speech, et cetera. The alert analyzer program 108 may extract contextual data from the features and/or the sensor data by providing the features and/or sensor data as input to a number of machine learning models that may be trained to identify patterns within the feature that are useful in assessing a hazard risk.

The alert analyzer program 108 may process the features to extract human contextual data, which may be contextual data regarding the behavior, actions, location, attire, gestures, et cetera of humans within the IoT environment, as well as a ratio of human occupants of a room to the size of the room.

In embodiments, the alert analyzer program 108 may comprise a room occupancy module, which receives visual data of a room comprising the IoT environment annotated with all human occupants located within the visual data, and may count the number of human occupants present within the room. In embodiments, the alert analyzer program 108 may use image processing techniques and/or a pre-provided floorplan of the IoT environment to extract dimensions of the room and/or identify safety measures in the room that might be useful in preventing an emergency, such as fire extinguishers, sprinklers, et cetera.

In embodiments, for example where the alert analyzer program 108 extracts movement data from the sensor data, the alert analyzer program 108 may comprise a gesture model. A gesture may be a movement of a part of a body to express an idea or meaning, and gestures performed by human occupants of the IoT environment represent important additional context that may be used to identify human behaviors that may influence the risk of a hazard occurring. The gesture model may be a machine learning model trained using a training dataset of gestures localized to the geographical region of the IoT environment; the region may be, for example, the county, the state/province, country, et cetera within which the IoT environment is located and which has regional gestures that may differ in meaning from equivalent gestures in other regions. The gesture model may receive the extracted movement data as input, may identify any gestures represented by the movement data, and may output an intent associated with each gesture. The intent may represent the meaning associated with the gesture; for example, a wave expresses greeting, a thumbs-up expresses assent, a head shake expresses disagreement, et cetera.

In embodiments, the alert analyzer program 108 may comprise a speech model; the speech model may be a multimodal foundation model that utilizing deep learning to identify a semantic connection between human speech and an object. The speech model may receive both text transcriptions of human speech and images of objects as inputs, and may output an intent, where the intent represents the intention of the human speaker with respect to the object, as indicated by the speech. For example, the speech model may receive a text transcription of human speech comprising the text “we would be lighting the candle” and an image from the video frame labeled with the text “candle on top of wooden table”; the speech model may identify the speaker's intention to light the candle identified in the image, and may output the intent “preparing to light candle.” In embodiments, the speech model may be configured to further accept gestures generated by the gesture model as inputs, and may factor the gestures of human occupants into the intent calculation.

The alert analyzer program 108 may extract object contextual data such as the location and type of objects within video sensor data, the combustibility of objects, identified objects, object count, object sounds, et cetera. In embodiments, the contextual data may be, at least in part, extracted from event data and/or historical data.

In embodiments, the alert analyzer program 108 may comprise a material model which receives visual sensor data containing one or more non-living objects present within the IoT environment, such as an article of furniture, a spilled liquid, an article of clothing, et cetera, and outputs a determination as to whether the object is combustible, which may be a value or score representing the combustibility of the object, with a higher score representing a higher combustibility. The material model may be trained on a materials training dataset which comprises materials annotated with a flammability score indicating the material's flammability, or combustibility, such that the material model may be able to receive an image of an object as input and output one or more of the materials comprising that object as well as a flammability score of each detected material. Flammability may represent the ease with which an object may burn when ignited, and the higher the flammability score, the more likely an object is to burn when ignited. In embodiments, the materials training dataset may include clothing materials, or the material model may be trained on a clothing materials dataset, enabling the material model to identify the material of articles of clothing worn by human occupants in images from the visual sensor data, and assign a flammability score to each article of clothing.

In embodiments, the material model may comprise an additional functionality, wherein the material model takes as input an image containing multiple non-living objects, and outputs a value representing the relation strength between the objects; the relation strength is based on the flammability score of each of the objects, and the higher the relation strength value, the higher the combustibility of the combined objects; in this way, the material model may represent interactions between objects that may increase or decrease the combustibility of those objects, such as proximity. For example, the material model may receive images of a flammable liquid spilled on a wooden table with a plastic cover; the material model may output a relation strength between the flammable liquid and the wooden table, between the flammable liquid and the plastic cover, and between the wooden table and the plastic cover based on the ranking score of each object; the scores may be higher than the individual scores of each object to represent the increased combustibility of three flammable objects located close together. In embodiments, for example where the material model is trained on a materials training dataset comprising clothing materials, the material model may output a relation strength between objects and clothing worn by human occupants.

In embodiments, the contextual data many comprise hazard contextual data; the alert analyzer program 108 may extract hazard contextual data from the sensor data, which may be data indicating the presence of a particular hazard, such as smoke, water damage, air quality, et cetera.

In embodiments, the alert analyzer program 108 may combine the outputs of the models and modules that generate contextual data from features, as well as contextual information derived from other sources as well as any relevant sensor data and/or features, into a composite cluster risk escalation matrix (CCREM). The CCREM may be a matrix organizing the contextual information into a format which can be ingested as input by the DDO AI model. The CCREM may include categories of contextual information including, for example, speech, gesture, number of occupants in a room, number of combustible objects in a room, dimensions of a room, combustibility of human attire in the room, presence of safety measures in the room, et cetera, organized with respect to a time domain. For example, in at least one embodiment, the CCREM may comprise the following input set at time domain TN: {human gestures, human conversations, proximity objects combustible nature, human attire, room dimension, human count, proximity safety systems/measures, room dimensions, object count, object sounds}. Another example of a CCREM is depicted below as follows:

| ATTRIBUTE | VALUE |
|---|---|
| Time: | 16:03 |
| Speech: | “Let's light some sparklers” |
| Gesture: | Support lighting sparkler. |
| Number of Occupants in Room: | 10 |
| Number of Combustible Objects: | 4 |
| Room Dimensions: | A*B*C |
| Human Attire: | Combustible |
| Presence of Safety Measures in Room: | No |

At 208, the alert analyzer program 108 may calculate a hazard risk based on the contextual data. In embodiments, the alert analyzer program 108 may calculate a hazard risk by providing the contextual data, for example in the form of the CCREM matrix, as input to a multimodal DDO AI model. In embodiments, the alert analyzer program 108 may convert visual features and audio features of the sensor data into natural language text, and may provide all inputs to the DDO AI model in a natural language text format. In embodiments, the DDO AI model may be trained on a historical labelled feature set, such that the DDO AI model is enabled to determine a single risk score based on the size of the space, the presence and position and movement of objects, the combustibility of those objects as well as human clothing, the presence and position and movement of human occupants as well as their behaviors, gestures, and speech, et cetera. The risk score may represent the risk of a hazard occurring within the IoT environment based on a holistic assessment of the contextual situation within the IoT environment at a given point in time as represented by the contextual information; in other words, the hazard risk is based on a synthesis of the semantic relationships between a broad range of factors represented by the contextual information, and a correlation strength of such factors with a hazard.

In embodiments, the hazard risk may comprise an aggregation of risk scores that the DDO AI model assigns to each human and each non-living object within the IoT environment; the risk score may be a product of the correlation strength between the humans and objects and a probable event based on, for example, human gestures, events propagated and captured by the sound/image/video sensors, et cetera. The probable event may be a hazard that might result from the current events and contextual factors of the IoT environment. For example, where the contextual information including speech and gestures indicate that a human intends to light a candle, and the candle is tilted sixty degrees relative to the level and flammable table surface it is sitting on, the DDO AI model may identify a fire as a probable event, and may assign a high risk score to the human, the candle, and the table to reflect that the behavior of the human and the presence, position, and flammability of the objects radically increases the chances of a fire breaking out. In embodiments, the alert analyzer program 108 may identify a probable event using a composite cluster and correlation with risk escalation via a Composite Cluster Risk Escalation Matrix function.

In embodiments, the alert analyzer program 108 may generate behavioral biometrics associated with a single location comprising the IoT environment, where the location may be a room or building. Behavioral biometrics may comprise matrices aggregating the various attributes and intents captured from human occupants with respect to non-living objects within the location; the alert analyzer program 108 may tokenize the representation by combining the intent features of non-living objects and the intent features of human occupants. The behavioral biometrics may represent the aggregated behaviors of humans occupying and moving through the location over time; the aggregated behaviors may include gestures, speech, movement patterns, and other human behaviors occurring within the location. The behavioral biometrics may be based on historical data and/or event data pertaining to the location. The alert analyzer program 108 may use the behavioral biometrics to perform a risk assessment of the location, and/or may provide the behavioral biometrics to the DDO AI model to improve hazard risk determination with respect to the location. In embodiments, responsive to determining that a threshold period of time has passed and/or the matrices have changed, the alert analyzer program 108 may perform a reinforcement of gestures, whereby the alert analyzer program 108 utilizes reinforcement learning techniques to reconstruct the token of the representation.

At 210, the alert analyzer program 108 may, responsive to the hazard risk exceeding a threshold amount, select one or more alarm generator devices based on the contextual data and the hazard risk. The alert analyzer program 108 may select alarm generator devices based on critical alarm procedures, and/or based on alarm type, device type, location, and priority inference.

Priority inference may represent the priority of escalation. The alert analyzer program 108 may select an alert action for each selected alarm generator device, which may be an action that the selected alarm generator device is to perform. For instance, for a siren, alert actions may include no action, low alarm, or high alarm. In embodiments, the alert action may specify the pattern, repetition, duration, content, volume, and/or pitch of an audible alarm, and/or the natural language content of a text alarm. The alert analyzer program 108 may select the alarms and alert actions based, for example, on a pre-provided rubric such as a Critical Alarm Procedure (CAP), on the output of a machine learning model, and/or on historical data, in addition to the hazard risk.

At 212, the alert analyzer program 108 may execute an alert action on the one or more selected alarm generator devices. The alert analyzer program 108 may execute the alert plan by transmitting commands to execute the alert action to each associated alarm generator device via, for example, the alarm generator manufacturer's specific interface, IOT communication protocols, etc.

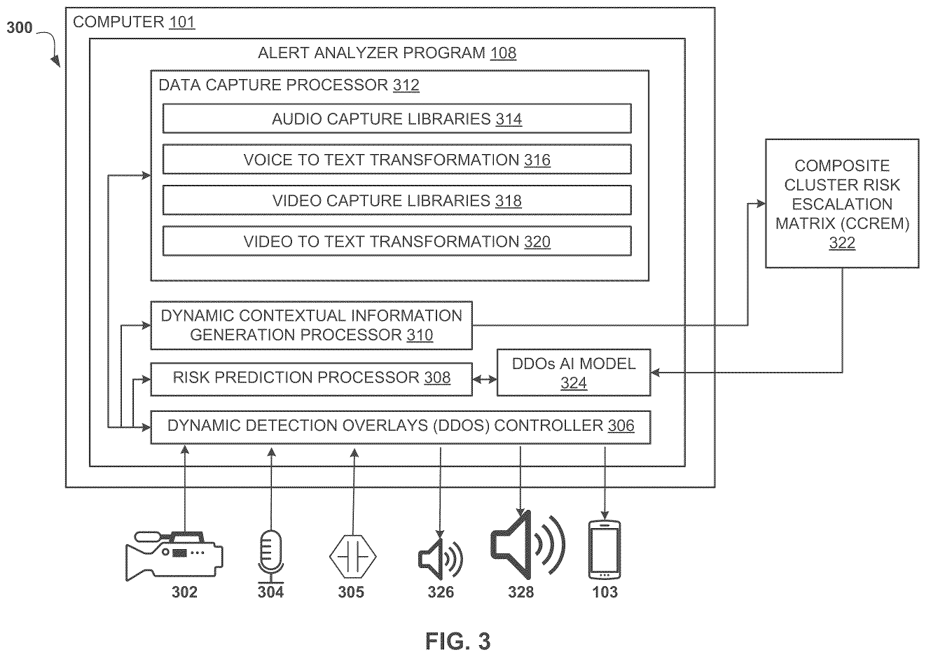

Referring now to FIG. 3, an exemplary alert analyzer system 300 is depicted according to at least one embodiment. The alert analyzer system 300 comprises a computer 101 running an alert analyzer program 108, as well as a number of video sensors 302, audio sensors 304, and hazard sensors 305, which in turn comprise IoT sensor set 125. The alert analyzer program 108 comprises a number of self-contained software modules specialized to perform particular tasks, and which communicate with each other internally over APIs: the dynamic detection overlays (DDOS) controller 306, the risk prediction processor 308, the dynamic contextual information generation processor 310, and the data capture processor 312.

The DDOS controller 306 is the orchestrator component of alert analyzer system 300, and interfaces with the various IoT devices of the alert analyzer system 300, such as the video sensors 302, the audio sensors 304, and the hazard sensors 305, and receives sensor data gathered by the sensors over protocols like RTP (Real-time Transport Protocol) for streaming. In embodiments, the IoT sensors may themselves perform analog-to-digital conversion (ADC) to convert the sensor data into a digital format and filter out unwanted noise before transmitting the sensor data to the DDOS controller 306. The DDOS controller 306 may interpret received sensor data using drivers such as ASIO (Audio Stream Input/Output), WDM (Windows Driver Model) Audio Drivers, ALSA (Advanced Linux Sound Architecture), V4L (Video4Linux), DirectX Video Drivers etc. The DDOS controller 306 may pass the interpreted sensor data to the risk prediction processor 308, the dynamic contextual information generation processor 310, and the data capture processor 312 for further processing.

The data capture processor 312 may comprise four sub-modules: the audio capture libraries 314, the voice-to-text transformation 316, the video capture libraries 318, and the video to text transformation 320. The data capture processor 312 receives the sensor data from the DDOS controller and processes the sensor data to extract audio and visual features of the sensor data pertaining to humans and objects within the IoT environment. The data capture processor 312 may utilize audio capture libraries 314 and voice to text transformation 316 to identify human speech and human paralinguistic sounds from audio sensor data. The data capture processor 312 may utilize video capture libraries and video to text transformation 320 to identify humans, objects, and written speech within video sensor data. The data capture processor 312 may pass the extracted features to the dynamic contextual information generation processor 310.

The dynamic contextual information generation processor 310 may receive the extracted features and may identify contextual information based on the features. The dynamic contextual information generation processor 310 may identify human contextual data such as gestures, behaviors, speech, number of people in a room, movement, and position of people, et cetera. The dynamic contextual information generation processor 310 may identify object contextual data such as number, position, and types of objects in a room, flammability of those objects, movement of objects, et cetera. The dynamic contextual information generation processor 310 may use the contextual data to populate a composite cluster risk escalation matrix (CCREM) 322. The CCREM 322 may be a matrix representing a number of contextual data elements that together may be used to determine a risk of a hazard. The dynamic contextual information generation processor 310 may transmit the CCREM 322 over an API to the dynamic detection overlay (DDO) AI model 324, which may be a multimodal regression-based machine learning model. The DDO AI model 324 may be trained on a historical labelled feature set. The DDO AI model 324 may ingest the CCREM 332 as input, and may output a risk score that represents the risk posed by the combination of contextual information provided within the CCREM. In embodiments, the DDO AI model 324 may also use a regression machine learning model to output an alarm category (low, medium, high), and one or more target alarm devices. The DDO AI model 324 may transmit its output to the risk prediction processor 308.

The risk prediction processor 308 may receive the alarm category and the one or more target alarm devices, and may generate an alert plan based on the alarm category and target alarm devices. The risk prediction processor 308 may provide the DDOs AI model 324 with the contextual data as input and may receive as output a risk assessment quantifying the risk of a hazard represented by the contextual data. If the risk of a hazard exceeds a predetermined threshold risk level associated with that hazard, where the threshold risk level represents the level of risk at which an alert should be issued for that hazard, the risk prediction processor 308 may generate an alert plan. The risk prediction processor 308 may generate the content of one or more alerts, which may be tailored to the particular hazard for which the alert is being issued. Based on the level of risk, the risk prediction processor 308 may select any number or combination of alarm generator devices, such as low alarm 326, high alarm 328, and/or user devices 103, for issuing an alarm to occupants of the IoT environment. Low alarm 326 and high alarm 328 may both be devices capable of generating a loud sound to alert nearby users, but may differ in power of the sound they are capable of generating: low alarms 326 may include devices such as smart thermostats, temperature and humidity sensors, et cetera which are equipped to produce a sound but cannot achieve more than modest volume; high alarms 328, on the other hand, may be devices such as smoke detectors, carbon monoxide alarms, et cetera, which are capable of generating extremely loud and piercing sounds and are often purpose built for the task. High alarms 328 may be too piercing and offensive to be appropriate for low-risk situations, where the low-to-moderate volumes of the low alarms 326 will suffice; however, in high-risk situations, loud and piercing alarms are most effective for alerting human occupants to the potential danger.

In embodiments, the risk prediction processor 308 may select an alert action for each of the selected alarm generator devices; the alert action may comprise an action that the alarm generator device will perform, and may be based on the capabilities of the alarm generator device. For example, where the alarm generator device is a simple siren, the alarm action may be “turn on for 5 minutes.” Where the alarm generator device is a user mobile device, the alarm action may be “transmit the following text message for display on the user device: SMOKE HAS BEEN DETECTED IN YOUR BUILDING, PLEASE MOVE TO THE DESIGNATED RALLY POINT.” The alert plan may comprise the number and type of alarm generator devices upon which the alert should be issued, as well as the alarm action for each device. The risk prediction processor 308 may pass the alert plan to the DDOS controller 306.

The DDOS controller 306 may receive the alert plan from the risk prediction processor 308, and may execute the alert plan on alarm generator devices integrated into, in communication with, or otherwise associated with the alert analyzer system 300 such as low alarms 326, high alarms 328, and user devices 103. The DDOS controller 306 may execute the alert plan by transmitting commands to execute the alert action to each associated alarm generator device over Smart Home APIs/SDKS, and/or IoT protocols such as message Queuing telemetry transport (MQTT) or constrained application protocol (CoAP), and/or wireless communication protocols such as Zigbee, Z-Wave, or Bluetooth. Alarm generator devices may include conventional fire alarms, wireless fire alarms, bells-only alarms, carbon monoxide detectors, et cetera.

It may be appreciated that FIGS. 2-3 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for operating alert generating devices to issue an alarm, the method comprising:
capturing, by a plurality of internet of things (IoT) sensors, sensor data in real time within an IoT environment;
extracting contextual data from the sensor data;
calculating a hazard risk based on the contextual data;
responsive to the hazard risk exceeding a threshold amount, selecting one or more alarm generator devices based on the contextual data and the hazard risk; and
executing an alert action on the one or more selected alarm generator devices.

2. The method of claim 1, wherein the extracting further comprises: identifying, by a material model, a material and a flammability associated with the material comprising an object within the IoT environment.

3. The method of claim 1, wherein the extracting further comprises: identifying, by a material model trained on a clothing materials dataset, a material and a flammability associated with the material of an article of clothing worn by a human occupant within the IoT environment.

4. The method of claim 1, wherein the extracting further comprises: identifying, by a gesture model trained on a gesture training dataset localized to a region comprising the IoT environment, one or more gestures performed by one or more human occupants.

5. The method of claim 4, wherein the extracting further comprises: identifying, by a speech model, a semantic connection between human speech, an object, and a gesture, based on an output of the gesture model.

6. The method of claim 1, wherein the selecting is based on alarm type, device type, location, and/or priority inference.

7. The method of claim 1, wherein the calculating is further based on behavioral biometrics comprising aggregated behaviors of human occupants within the IoT environment over time.

8. A computer system for operating alert generating devices to issue an alarm, the computer system comprising:
one or more internet of things (IoT) sensors, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing, by a plurality of internet of things (IoT) sensors, sensor data in real time within an IoT environment;
extracting contextual data from the sensor data;
calculating a hazard risk based on the contextual data;
responsive to the hazard risk exceeding a threshold amount, selecting one or more alarm generator devices based on the contextual data and the hazard risk; and
executing an alert action on the one or more selected alarm generator devices.

9. The computer system of claim 8, wherein the extracting further comprises: identifying, by a material model, a material and a flammability associated with the material comprising an object within the IoT environment.

10. The computer system of claim 8, wherein the extracting further comprises: identifying, by a material model trained on a clothing materials dataset, a material and a flammability associated with the material of an article of clothing worn by a human occupant within the IoT environment.

11. The computer system of claim 8, wherein the extracting further comprises: identifying, by a gesture model trained on a gesture training dataset localized to a region comprising the IoT environment, one or more gestures performed by one or more human occupants.

12. The computer system of claim 11, wherein the extracting further comprises: identifying, by a speech model, a semantic connection between human speech, an object, and a gesture, based on an output of the gesture model.

13. The computer system of claim 8, wherein the selecting is based on alarm type, device type, location, and/or priority inference.

14. The computer system of claim 8, wherein the calculating is further based on behavioral biometrics comprising aggregated behaviors of human occupants within the IoT environment over time.

15. A computer program product for operating alert generating devices to issue an alarm, the computer program product comprising:
one or more computer-readable tangible storage medium and program instructions stored on at least one of the one or more tangible storage medium, the program instructions executable by a processor to cause the processor to perform a method comprising:
capturing, by a plurality of internet of things (IoT) sensors, sensor data in real time within an IoT environment;
extracting contextual data from the sensor data;
calculating a hazard risk based on the contextual data;
responsive to the hazard risk exceeding a threshold amount, selecting one or more alarm generator devices based on the contextual data and the hazard risk; and
executing an alert action on the one or more selected alarm generator devices.

16. The computer program product of claim 15, wherein the extracting further comprises: identifying, by a material model, a material and a flammability associated with the material comprising an object within the IoT environment.

17. The computer program product of claim 15, wherein the extracting further comprises: identifying, by a material model trained on a clothing materials dataset, a material and a flammability associated with the material of an article of clothing worn by a human occupant within the IoT environment.

18. The computer program product of claim 15, wherein the extracting further comprises: identifying, by a gesture model trained on a gesture training dataset localized to a region comprising the IoT environment, one or more gestures performed by one or more human occupants.

19. The computer program product of claim 18, wherein the extracting further comprises: identifying, by a speech model, a semantic connection between human speech, an object, and a gesture, based on an output of the gesture model.

20. The computer program product of claim 15, wherein the selecting is based on alarm type, device type, location, and/or priority inference.
